(19) United States
(12) Patent Application Publication
(10) Pub. No.: US 2017/0156355 A1
(43) Pub. Date: Jun. 8, 2017

(54) APPARATUS AND METHOD FOR FRUIT DEGREENING

(71) Applicant: American Incorporated, Visalia, CA (US)

(72) Inventor: Corwyn OLDFIELD, Visalia, CA (US)

(73) Assignee: American Incorporated, Visalia, CA (US)

(21) Appl. No.: 14/962,750

(22) Filed: Dec. 8, 2015

(51) Int. Cl. A23B 7/152

(52) U.S. Cl. CPC A23B 7/152; A23V 2002/00

(57) ABSTRACT

An apparatus for fruit degreening and method of use. The apparatus may comprise: a plurality of air-permeable fruit storage compartments, a climate control unit configured to maintain temperature and/or humidity inside the apparatus; a gas exchanger configured to hold a quantity of degreening agent and dispense it as necessary, and a fan array including a plurality of centrifugal fans, the fan array configured to direct airflow in a continuous loop between at least the fan array, the plurality of fruit storage compartments, the climate control unit, and the gas exchanger. The fan array may be used to evenly conduct air through either all of the storage compartments or some percentage of them, resulting in generally faster and less risky degreening.

### BACKGROUND

When certain kinds of fruit, such as citrus fruit, are harvested, the peel color of said fruits may sometimes be greener than typically desired. For example, oranges harvested from the same area may remain green or partly green, or may have already reached full coloration, when the area is harvested. What color the oranges actually are when harvested may depend on various environmental factors, such as the night-time temperatures in the area.

In most cases, the fruits that are green or which are partially green when harvested will be perfectly good to eat despite their appearance, though in some cases green fruits and ripe-looking fruits may exhibit different fullnesses of flavor, juicinesses, and sweetnesses. However, consumers, particularly those in non-fruit-growing locales, typically demand full-colored fruits. As such, a process for degreening the fruits that are green or partially green when harvested is necessary.

Degreening is the process where the green chlorophyll pigments in the peel are broken down and the yellow and orange xanthophyll and carotenoid pigments are formed. Typically, this is done by exposing the fruits to a quantity of ethylene gas under controlled conditions of temperature, humidity and ventilation for an extended period of time. This typically involves storing a quantity of the fruit in a sealed room, filling the room with a certain amount of ethylene gas, and then attempting to control the internal atmosphere of the room such that the amount of ethylene gas that that each of the fruits is exposed to stays substantially uniform.

However, there can be irregularities in the degreening process. Effective degreening of a batch of fruit requires that all of the fruit in the batch be kept at a constant and controlled temperature and humidity, and that the entire batch be adequately and consistently ventilated. When one of these is not accomplished, the fruit can be damaged or spoiled. To give one example, if the degreening atmosphere is not kept at a sufficiently high humidity, the fruit may lose size or may develop one of several fruit diseases; for example, some of the fruit may develop anthracnose infections, which results in a distinctive brown “tear-staining” pattern on the fruit. Similar problems may result if the fruit is exposed to an atmosphere that is too high or too low in temperature, or which has too much or too little ethylene concentration.

### SUMMARY

An apparatus and method for fruit degreening may be disclosed. An apparatus for fruit degreening may comprise: an internal volume storing a quantity of air and a plurality of fruit storage compartments, said fruit storage compartments being permeable to the flow of air and configured to hold a quantity of fruit; a climate control unit configured to maintain at least one of: the temperature of the air inside the apparatus, and the humidity of the air inside the apparatus; a gas exchanger configured to hold a quantity of degreening agent, and further configured to dispense a quantity of degreening agent into the air inside the apparatus; and a fan array including a plurality of centrifugal fans, the fan array configured to direct airflow in a continuous loop between at least the fan array, the plurality of fruit storage compartments, the climate control unit, and the gas exchanger.

A method for fruit degreening may comprise: storing a quantity of fruit in an apparatus for fruit degreening, the apparatus for fruit degreening comprising a plurality of fruit storage compartments, a climate control unit, a gas exchanger, and a fan array including a plurality of centrifugal fans, and containing a quantity of air; adding, via the gas exchanger, a quantity of degreening agent to the air in the apparatus; directing, using the fan array, a volume of the air in the apparatus through the plurality of fruit storage compartments, such that the airflow through the plurality of fruit storage compartments is evenly distributed throughout a plurality of the plurality of fruit storage compartments; conducting the volume of air through the plurality of fruit storage compartments; and conducting said volume of air via a closed loop back to the fan array.

### BRIEF DESCRIPTION OF THE FIGURES

FIG. 1 is an exemplary embodiment of a degreening chamber, as seen from one side.

FIG. 2 is an exemplary embodiment of a degreening chamber, as seen from the front.

FIG. 3 is an exemplary embodiment of the air handler portion of a degreening chamber, as seen from the top.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

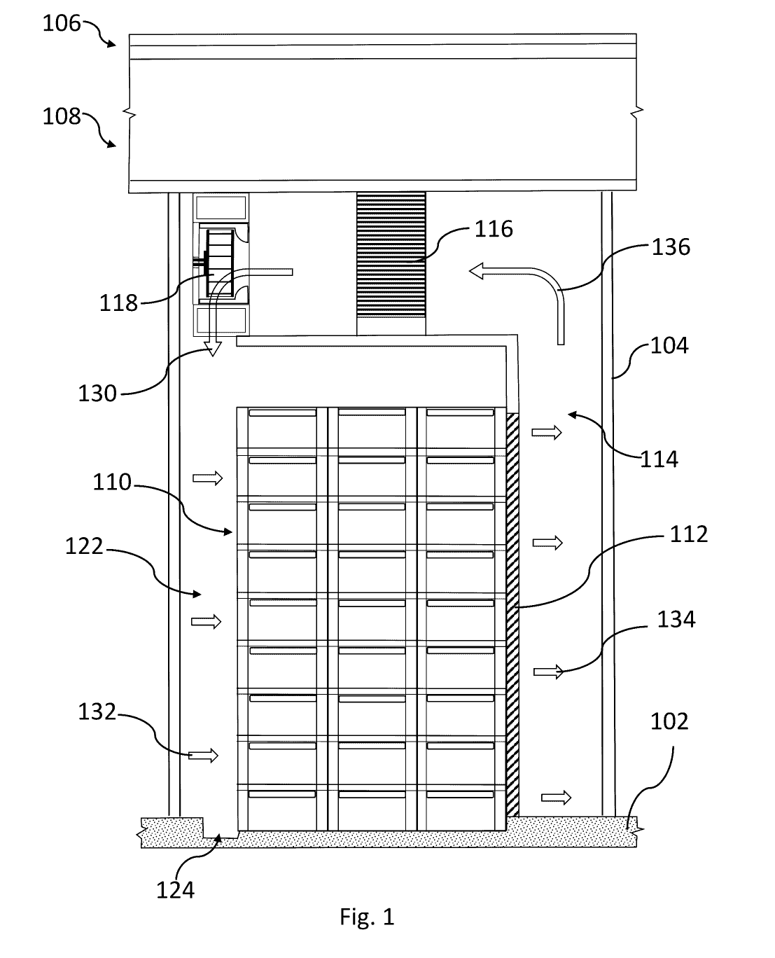

FIG. 1 displays an exemplary embodiment of a degreening chamber 100, as housed inside a room or building suited for that purpose. Such a degreening chamber 100 may have, for example, a solid floor 102, a series of perimeter walls that insulate the room from the outside 104, and a roof 106. One or more of the series of perimeter walls may include an access door, as desired. According to an exemplary embodiment, degreening chamber 100 may be substantially sealed or sealable, allowing little to no airflow between the degreening chamber 100 and the surroundings when so sealed.

There are a variety of circumstances where one might want to degreen a batch of fruit. For example, according to one exemplary embodiment, one might want to degreen fruit before it is shipped, so that the supplier can ensure that all fruit is degreened to their satisfaction or so the fruit makes a good impression on the recipient. According to another exemplary embodiment, one might want to leave fruit in its unripened state while it is shipped, in order to avoid or limit spoilage of the fruit in transit. Different exemplary embodiments of a degreening chamber 100 may be possible in order to fit these requirements. For example, according to one exemplary embodiment, degreening chamber 100 may be secured to an external floor 102 and may be immobile; such an embodiment may be used for, for example, particularly large degreening chambers 100 intended to provide degreening to a substantial quantity of fruit before it is shipped. According to a second exemplary embodiment, a degreening chamber 100 may instead be constructed to be mobile or portable, and may be less securely fastened to an external floor 102 or may have its own floor 102. This allows for a variety of degreening chambers 100 to exist that fulfill different roles. For example, a large degreening chamber 100 may be used at a location where food is collected and harvested in order to ripen large quantities of fruit before transport, while smaller degreening chambers 100 may be used at, for example, grocery store supply hubs in order to ripen a quantity of fruit after it has been received. Other embodiments are possible; for example, fruit may even be ripened in transit in a specialized trailer.

According to an exemplary embodiment, the roof 106 may be insulated so as to make it easier for the temperature and humidity in the degreening chamber 100 to be held constant without, for example, loss or gain of heat from the surroundings. The roof 106 may also enclose an air pocket 108; this air pocket 108 may provide additional insulation to the degreening chamber 100 and may make it easier for the internal conditions within the degreening chamber to be kept constant and uniform.

Turning now to the inner workings of the degreening chamber 100, degreening chamber may include a plurality of fruit storage compartments 110, a rear air duct 114, a climate control unit 116, a fan array 118, a frontal air duct 122, and a gutter 124. Degreening chamber 100 may also include an internal barrier or wall substantially permeable to airflow 112 and located between the frontal air duct 122 and rear air duct 114.

According to one exemplary embodiment of the degreening chamber 100, fruit storage compartments 110 may be configured to accept a quantity of fruit. Fruit storage compartments 110 may be fixed in place, or may be movable or removable, as desired. Fruit storage compartments 110 may be ventilated to allow a quantity of air to be passed through them. According to an exemplary embodiment, air may be passed from the frontal air duct 122 and through the fruit storage compartments 110 into the rear air duct 114.

According to an exemplary embodiment, the air inside the degreening chamber 100 may be dosed with a quantity of ethylene or other degreening agent, and may be constantly circulated around the degreening chamber 100. For example, in step 130, air may emerge from the fan array 118, and then in step 132 may be conducted into the frontal air duct 122 by the action of the fan array 118. In step 134, air may then be passed through the fruit storage compartments 110 and into the rear air duct 114; this may, for example, be done through an internal barrier 112 or wall. In step 136, the air may then be conducted out of the rear air duct 114, past the climate control unit 116, and back to the fan array 118.

According to one exemplary embodiment, fruit storage compartments 110 may be removable; for example, they may be one or multiple large storage compartments that can be loaded into the degreening chamber 100 from a vehicle. According to another exemplary embodiment, fruit storage compartments 110 may be a plurality of fruit storage crates or other containers, which may be stacked inside the degreening chamber 100, as desired. According to an exemplary embodiment, some or all of the fruit storage containers may have a mesh design or may otherwise allow air to be passed through them. According to an alternative exemplary embodiment, some or all of the fruit storage containers may have a portion that, when the fruit storage containers are stacked, ensures that some part of the fruit storage container contents remain open to its surroundings; for example, an exemplary fruit storage container may have pegs on the bottom portion or raised edges on the top portion such that the fruit storage containers do not rest flush with each other when stacked.

According to an alternative embodiment, fruit storage compartments 110 may be fixed in place rather than being a plurality of removable containers; alternatively, both may be used. For example, fruit storage compartments 110 may be a plurality of drawers or trays. According to such an embodiment, fruit may be placed within the fruit storage compartments 110 before degreening, and may be removed from the fruit storage compartments 110 after degreening. Other embodiments of fruit storage compartments 110 may also be envisioned.

According to an exemplary embodiment, an internal barrier 112 or wall may be provided that may be substantially permeable to airflow, and may be substantially stiff and strong to allow a plurality of fruit storage compartments 110 to be stacked or leaned against it. According to one exemplary embodiment, an internal barrier 112 may be noncontiguous, and may comprise a plurality of vertical bars or supports that serve as a guide for the fruit storage compartments 110. According to another exemplary embodiment, internal barrier 112 may be contiguous, and may be constructed from a material that is substantially permeable to airflow. According to another exemplary embodiment, it may have a mesh design or may otherwise be ventilated. According to another exemplary embodiment, the internal barrier 112 may be removed entirely; according to such an embodiment, a guide may be placed in the floor or on the ceiling of the degreening chamber 100 in order to ensure that the plurality of fruit storage compartments 110 has been inserted correctly. Alternatively, internal barrier 112 may be merged with one or more fruit storage compartments 110, for example if the plurality of fruit storage compartments 110 is a fixed structure.

According to an exemplary embodiment, climate control unit 116 may be a system for controlling the temperature and/or the humidity of the air. For example, it may be a heater or plurality of heaters, an air conditioner or plurality of air conditioners, a humidifier or plurality of humidifiers, or another such system, as desired. Climate control unit 116 may also be a combination of such systems. For example, climate control unit 116 may control the temperature of the air inside the degreening chamber 100 at a certain level, and may include heating and cooling units; climate control unit 116 may also control the humidity of the air inside the degreening chamber 100, and may include a humidification unit. According to an alternative embodiment, climate control unit 116 may also maintain the desired composition of the air inside the degreening chamber 100, and may, for example, add ethylene and remove carbon dioxide from the air, as desired.

According to an exemplary embodiment, fan array 118 may be a centrifugal fan or plurality of centrifugal fans, as desired. According to an exemplary embodiment, any type or blade configuration of centrifugal fan may be used. For example, a radial tip or radial blade centrifugal fan, a forward or backward curved or inclined centrifugal fan, an open paddle wheel centrifugal fan, or an airfoil centrifugal fan may be used. Multiple types of centrifugal fans may also be used. Other types of fans, such as mixed-flow fans or cross-flow fans, may also be used instead, or may be used in combination with centrifugal fans, as desired.

The fan array 118 may provide sufficient static pressure to deliver the desired airflow for degreening through one or more fruit storage compartments 110, such as a plurality of fruit bins. According to an exemplary embodiment, the fan array 118 may create a high pressure plenum that evenly, or substantially evenly, drives air across the entire room; an even distribution of airflow may cause the rate of degreening of the fruit in the fruit storage compartments 110 to be more substantially uniform, and may increase the rate of degreening with less risk to the fruit in the fruit storage compartments 110.

According to an exemplary embodiment, degreening chamber 100 may have a gutter 124 or a plurality of gutters, or another drainage system. Gutter 124 may ensure that any excess liquid, such as water or excess ethylene, can be drained off of the fruit in the fruit storage compartments 110.

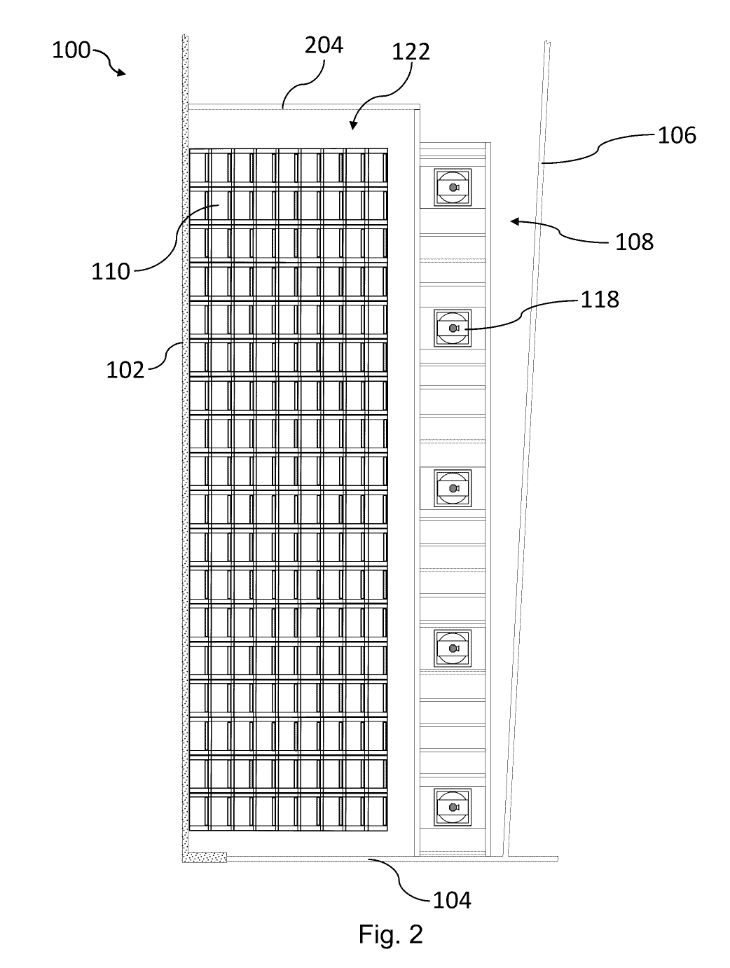

Turning now to FIG. 2, FIG. 2 displays an exemplary embodiment of a degreening chamber 100 as seen from the front. (For reference, in FIG. 1, this would be the left side of the degreening chamber 100.) As in FIG. 1, such a degreening chamber 100 may have, for example, a solid floor 102, a series of perimeter walls that insulate the room from the outside 104, and a roof 106. According to an exemplary embodiment, degreening chamber 100 may be substantially sealed or sealable, allowing little to no airflow between the degreening chamber 100 and the surroundings when so sealed. Degreening chamber 100 may also have an air pocket 108 to provide insulation, and may have a fan array or plurality of fans 118.

According to an exemplary embodiment, degreening chamber 100 may be a separate room inside a larger building, and may be isolated from the larger building by a plurality of indoor walls 204. This may allow, for example, multiple degreening chambers 100 to be located within the same building, which may allow for greater efficiency. For example, different degreening chambers can be run for different lengths of time or at different temperatures.

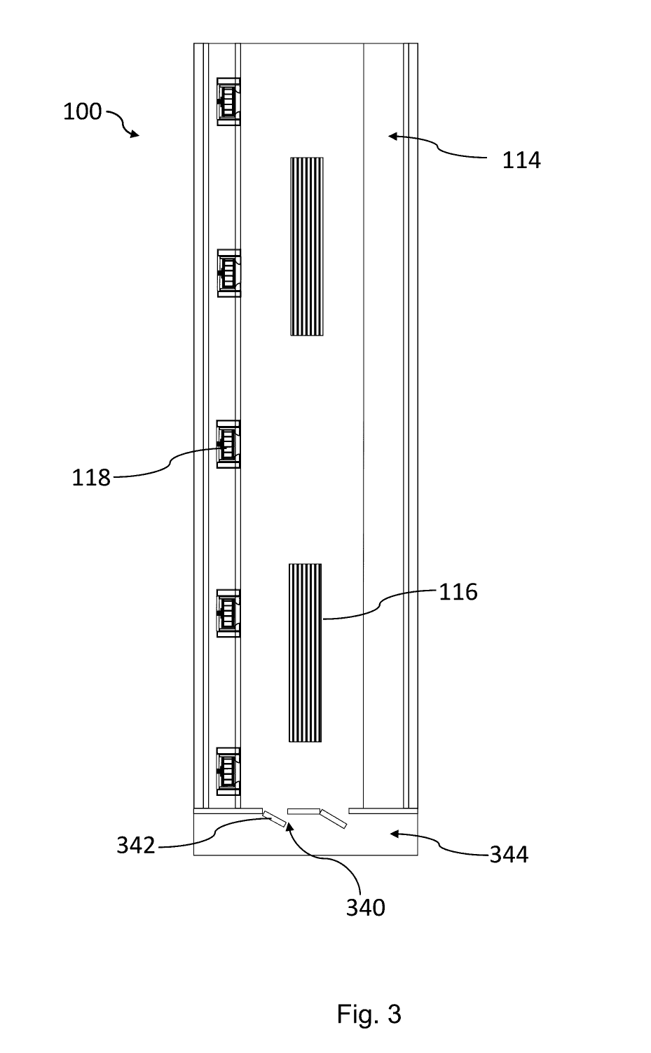

Turning now to FIG. 3, FIG. 3 displays an exemplary embodiment of an air handler portion of a degreening chamber 100, as seen from the top. This air handler portion of the degreening chamber 100 may include a fan array 118 or plurality of fans, as well as a climate control unit 116 or plurality thereof. According to an exemplary embodiment, the air handler portion of the degreening chamber 100 may be sufficiently large to allow access to the air handler portion of the degreening chamber 100 by maintenance personnel.

The air handler portion of the degreening chamber 100 may also include a gas exchanger 340, the gas exchanger 340 including a valve 342 and a reservoir 344. The gas exchanger 340 may be used to regulate the composition of the air inside of the degreening chamber 100. For example, the gas exchanger reservoir 344 may be filled with a quantity of ethylene or other degreening agent at a high concentration, such that ethylene in the air of the degreening chamber 100 is replenished at approximately the same rate as it is used. Valve 342 may be used to regulate the quantity of air that can be exchanged between the gas exchanger reservoir and the rest of the degreening chamber 100. Reservoir 344 may be stagnant or may have an inflow or an outflow; for example, reservoir 344 may be used to add ethylene to the degreening chamber 100 from an outside supply, and may simultaneously be used to remove waste products, such as carbon dioxide, to an outside sink. Other uses for the gas exchanger 340 may be envisioned.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for fruit degreening, comprising:
an internal volume storing a quantity of air and a plurality of fruit storage compartments, said fruit storage compartments being permeable to the flow of air and configured to hold a quantity of fruit;
a climate control unit configured to maintain at least one of: the temperature of the air inside the apparatus, and the humidity of the air inside the apparatus;
a gas exchanger configured to hold a quantity of degreening agent, and further configured to dispense a quantity of degreening agent into the air inside the apparatus; and
a fan array including a plurality of centrifugal fans, the fan array configured to direct airflow in a continuous loop between at least the fan array, the plurality of fruit storage compartments, the climate control unit, and the gas exchanger.

2. The apparatus of claim 1, wherein the apparatus is substantially sealed from the external environment.

3. The apparatus of claim 1, wherein the apparatus is insulated.

4. The apparatus of claim 1, wherein the degreening agent is ethylene.

5. The apparatus of claim 1, wherein the gas exchanger further removes waste gases from the air inside the apparatus.

6. The apparatus of claim 1, wherein the plurality of fruit storage compartments comprises a plurality of fruit storage bins.

7. The apparatus of claim 1, wherein the plurality of fruit storage compartments comprises a fixed structure.

8. The apparatus of claim 1, wherein airflow through the plurality of fruit storage compartments is evenly distributed throughout a plurality of the plurality of fruit storage compartments.

9. The apparatus of claim 1, wherein the apparatus further includes a guide located behind the plurality of fruit storage compartments.

10. The apparatus of claim 1, wherein the apparatus further includes a gutter.

11. The apparatus of claim 1, wherein the apparatus further includes an air pocket trapped between the ceiling of the apparatus and the outside environment.

12. The apparatus of claim 1, wherein the quantity of fruit comprises citrus fruit.

13. A method of fruit degreening, comprising:
storing a quantity of fruit in an apparatus for fruit degreening, the apparatus for fruit degreening comprising an internal volume including a plurality of fruit storage compartments, a climate control unit, a gas exchanger, and a fan array including a plurality of centrifugal fans, and containing a quantity of air;
adding, via the gas exchanger, a quantity of degreening agent to the air in the apparatus;
directing, using the fan array, a volume of the air in the apparatus through the plurality of fruit storage compartments, such that the airflow through the plurality of fruit storage compartments is evenly distributed throughout a plurality of the plurality of fruit storage compartments;
conducting the volume of air through the plurality of fruit storage compartments; and
conducting said volume of air via a closed loop back to the fan array.

14. The method of claim 13, wherein the apparatus is substantially sealed from the external environment.

15. The method of claim 13, further comprising removing waste gases from the air in the apparatus.

16. The method of claim 13, wherein storing the quantity of fruit in the apparatus for fruit degreening comprises putting the fruit in a plurality of air-permeable containers, and stacking said containers within the internal volume of the apparatus for fruit degreening.
